(19) United States
(12) Patent Application Publication
(10) Pub. No.: US 2009/0111296 A1
(43) Pub. Date: Apr. 30, 2009

(54) Latching device used for locking two daughter printed circuit boards in connector set

(75) Inventor: Jian-Kuang Zhu, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/287,089

(22) Filed: Oct. 6, 2008

(30) Foreign Application Priority Data
Oct. 26, 2007 (CN) 200720044757.6
Oct. 26, 2007 (TW) 96218024

(51) Int. Cl. H01R 12/00

(52) U.S. Cl. 439/78

(57) ABSTRACT

A latching device (1) for retaining two daughter printed circuit boards (6), includes a fixing member (2) of one piece and a pair of metallic latching members (3) secured to the fixing member. The fixing member includes an elongated main body (20), a pair of supporting portions (21) extending from each side of the main body to support one daughter printed circuit board. The latching members cooperate with the supporting portions to latch and unlatch the daughter printed circuit boards.

### BACKGROUND OF THE INVENTION

1. Field of the Invention

The present invention relates to a latching device, and particularly to a latching device cooperating with the electrical connector set to hold two daughter printed circuit boards thereon.

2. Description of the Related Art

Taiwan Patent Number M261882 discloses one kind of latching device, which separates from a card edge connector while latches and unlatches a daughter printed circuit board in the connector. The latching device includes a base portion to support one end of the daughter printed circuit board and a spring arm to press against the daughter printed circuit board. The latching device of the this kind corresponds one connector to latch one daughter printed circuit board only, which is not satisfy a fine performance of expansion sometimes.

Taiwan Patent Number M283401 discloses a pair of latching devices for use with a stacked electrical connector. One latching device is opposite to the stacked connector to latch a daughter printed circuit board in a lower connector body while another latching device is at two opposite sides of the stacked connector to latch a daughter printed circuit board in a higher connector body. The pair of latching devices in the patent still has the principle that one latching device retains one daughter printed circuit board. Geometric profiles of the pair of latching devices are complex, and have difficulties in manufacturing. Furthermore, the stacked daughter printed circuit boards occupy a large height.

Therefore, an improved latching device and arrangement on the printed circuit board are required.

### SUMMARY OF THE INVENTION

An object of the present invention is to provide a latching device which is used to retain two daughter printed circuit boards.

In order to achieve the above-mentioned one object, a latching device for retaining two daughter printed circuit boards, includes a fixing member of one piece and a pair of metallic latching members secured to the fixing member. The fixing member includes an elongated main body, a pair of supporting portions extending from each side of the main body to support one daughter printed circuit board. The latching members cooperate with the supporting portions to latch and unlatch the daughter printed circuit boards. On the other aspect, two latching devices selectively used with a common connector set for holding two different cards, are desired too.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of a latching device and the corresponding card edge connectors mounted upon a mother printed circuit board;

FIG. 2 is a perspective view of the latching device and the corresponding card edge connectors on the mother printed circuit board of FIG. 1, and the corresponding daughter printed circuit boards thereof.

FIG. 3 is an exploded perspective view of the latching device of FIG. 11.

FIG. 4 is an assembled perspective view of the latching device, the connector and the associated printed circuit board of a second embodiment.

FIG. 5 is an perspective view of the latching device of a second embodiment.

FIG. 6 is an exploded perspective view of the latching device of a second embodiment.

FIG. 7 is an exploded perspective view of the latching device of a second embodiment in an upside down manner.

FIG. 8 is an assembled perspective view of the latching device, the connector and the associated printed circuit board of a second embodiment, used with a long card.

FIG. 9 is an assembled perspective view of the latching device, the connector and the associated printed circuit board of a second embodiment, used with a short card.

FIG. 10 is an exploded perspective view of the latching device of a third embodiment.

FIG. 11 is an exploded perspective view of the latching device of a fourth embodiment.

### DETAILED DESCRIPTION OF THE INVENTION

Reference will now be made to the drawing figures to describe a preferred embodiment of the present invention in detail.

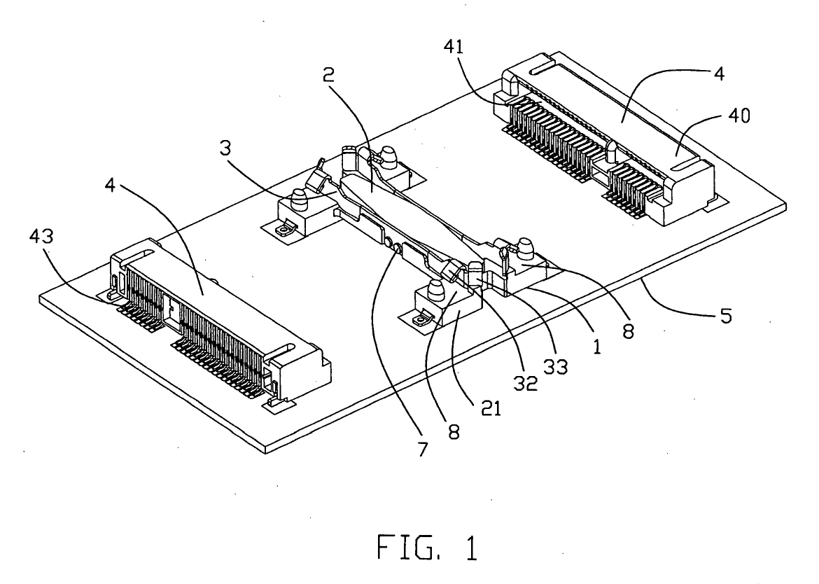

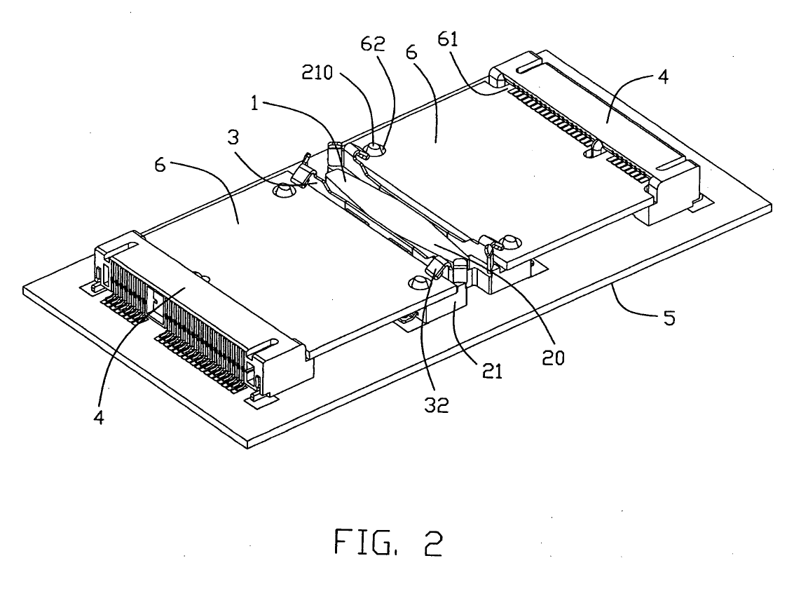

Referring to FIG. 1 and FIG. 2, a latching device 1 and a pair of card edge electrical connectors 4 separately positioned on two sides of the latching device 1 are commonly mounted to a mother printed circuit board (PCB) 5 for holding two daughter printed circuit boards (PCB) 6 in the connectors 4.

The two electrical connectors 4 are similar to each other and each includes an insulative housing 40 and a plurality of conductive contacts 43 therein. The insulative housing 40 defines a receiving slot 41 along a longitudinal direction thereof, and the contacts 43 are arranged in two rows in the opposite inner sides of the slot 41. One end of the contact 43 is positioned in the slot 41, and the other end of the contact 43 is mechanically and electrically connecting to the mother PCB 5. A front mating portion 61 of each daughter PCB 6 is inserted into the slot 41 to mechanically and electrically connect to said one end of the corresponding contact 43 so as to form an electrical connection between the daughter PCB 6 and the mother PCB 5. The rear end of each daughter PCB 6 defines a pair of positioning holes 62 at two opposite side thereof.

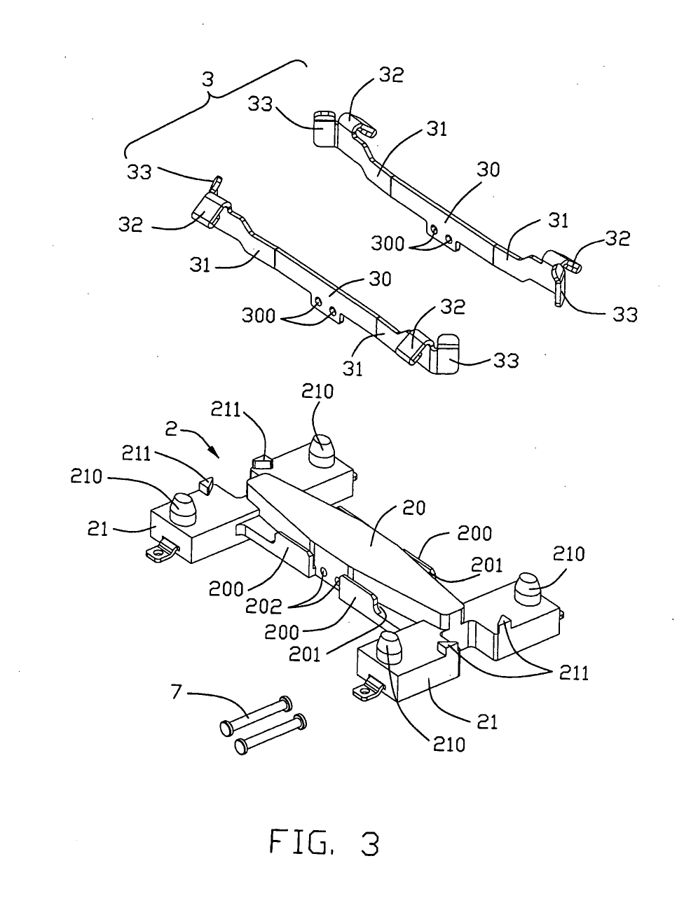

Referring to FIG. 3, the latching device 1 includes a one piece fixing member 2 and a pair of latching members 3. The fixing member 2 is made from insulative material and defines an elongated main body 20. A pair of supporting portions 21 respectively and unitarily extend from two opposite ends of each side of the main body 20 toward one connector 4 as a H-like shape. The body 20 defines a pair of retaining portions 200 projecting upwards and located around a middle portion thereof along the longitudinal direction at each side of the body 20. The retaining portion 200 spaces from the sidewall of the main body 20 with a retaining slot 201 defined therebetween. A pair of through holes 202 run through the main body 20 along a direction perpendicularly to the longitudinal direction, and the through holes 202 are located between the pair of retaining portions 200. Each supporting portion 21 defines a positioning post 210 and a blocking portion 211 both extending upwards. The positioning post 210 is located adjacent to the front end of the supporting portion 21, and the blocking portions 211 are positioned outside of the posts 210 and adjacent to the main body 20. The fixing member 2 is symmetrical.

The two latching members 3 are made from metal sheet respectively, and each includes a retaining section 30, a pair of spring arms 31 extending from the retaining section 30 and a hook section 32 located at a distal end of each spring arm 31. The hook section 32 extends from a top edge of the spring arm 31 toward the connector 4 with an oblique guiding face thereon. An operation section 33 at the distal end of the spring arm extends away from the connector 4. The retaining section 30 includes two attaching holes 300 corresponding to the through holes 200.

The latching members 3 are assembled on two sides of the main body 20, and the retaining section 30 is loaded into the retaining slots 201 and fastened to the fixing member 2 via a pair of rivets 7 extending through the through holes 200 and the corresponding attaching holes 300. As shown in FIG. 1, a retaining space 8 is formed between the supporting portions 21 and hook sections 32 for holding the rear portion of the daughter PCB 6 at each side of the main body 20. The latching device 1 is symmetrical, and the two latching members 3 are symmetrically positioned at two sides of the body 20 for locking the rear portion of the two daughter PCBs 6 respectively.

During assembling, the front edge of each daughter PCB 6 is inserted initially into the slot 41 of each card edge connector 4, and rear edge of each daughter PCB 6 is successively downwardly moved toward the latching device 1 and passing the hook sections 32 of each latching member 3, and the spring arms 31 are rearwards deflected. At the same time, the daughter PCBs 6 are correctly positioned relative to the mother printed circuit board 5 via the positioning posts 210 extending through the positioning holes 62 in a stable downward movement. When the rear edge of each daughter PCB 6 completely passes the hook sections 32, the daughter PCB 6 is essentially located in the retaining space 8 and the spring arms 31 resume the original position to have the hook sections 32 downwardly press the rear edge of the daughter PCB 6. The blocking portion 211 is used to prevent the spring arm 31 from forward over-deflection. Under this condition, the daughter PCB 6 can not further downwardly moved by means of the supporting portions 21, and further horizontally moved by means of the positioning posts 210 extending through the positioning holes 62. During disassembling, the operation sections 33 are moved rearwards to have the corresponding spring arms 31 and hook section 32 moved rearwards associatively, and the rear edge of each daughter PCB 6 is disengaged from the hook sections 32. The main body 20 can prevent the spring arm 31 from rearward over-deflection.

The simple latching device 1 is symmetrical, and defines a latching member 3 at each side thereof, so that one latching device 1 can retain two daughter PCBs 6 at two sides thereof in a same level above the mother printed circuit board 5, which has a fine performance of expansion, and restricts the height.

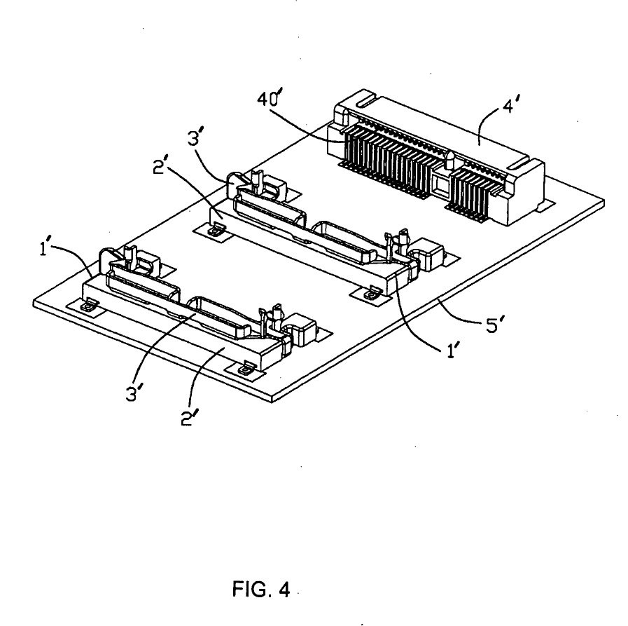

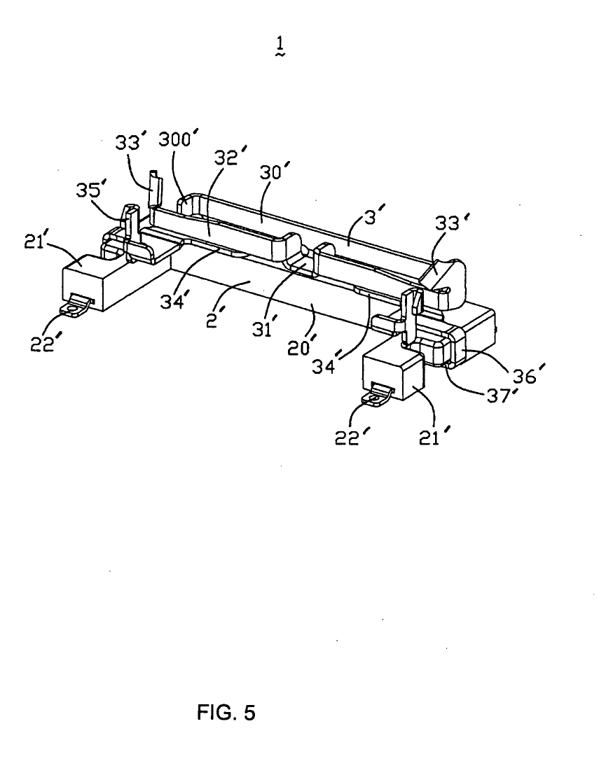

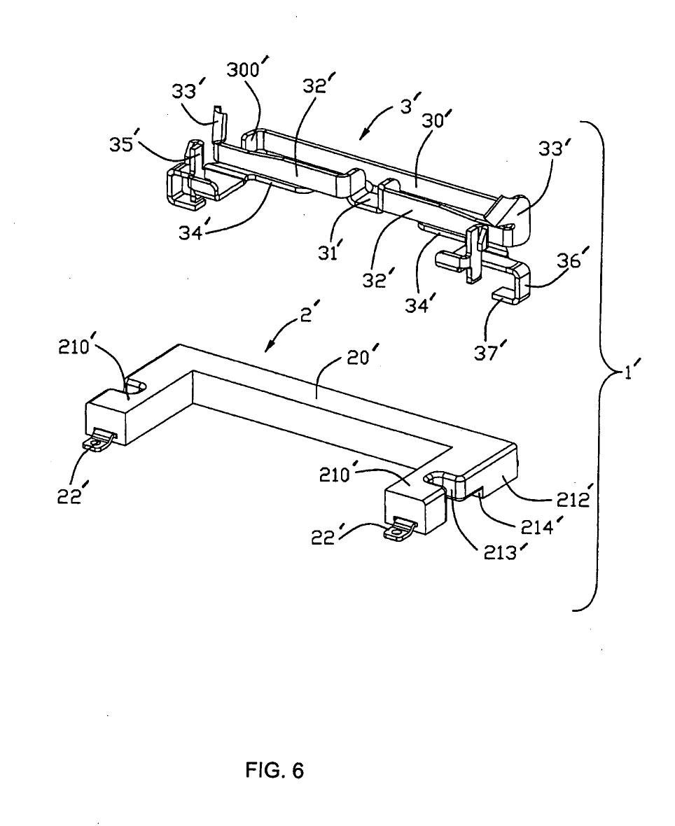

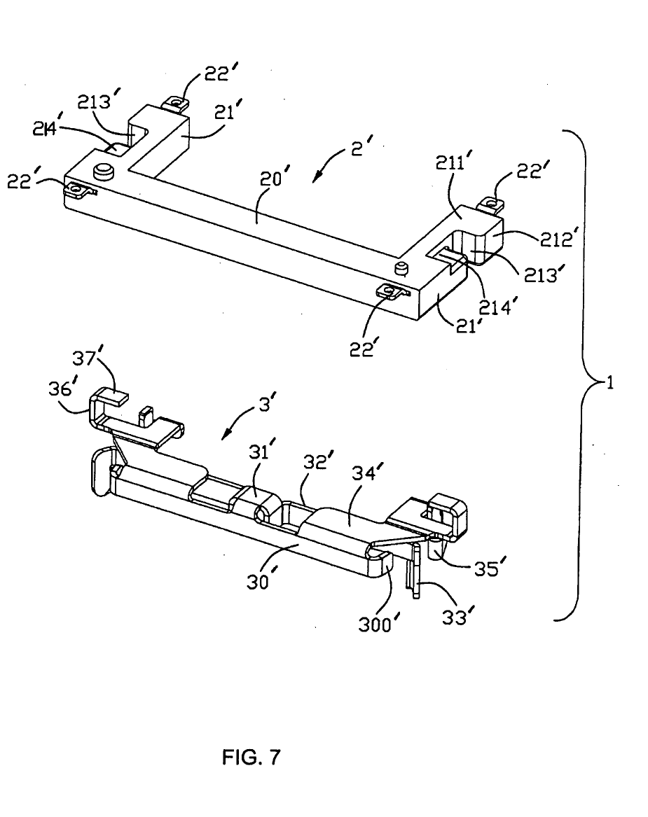

FIGS. 4-9 discloses a second embodiment of the invention, showing a pair of latching device 1′ including the corresponding fixing member 2′ and the corresponding latching member 3′, mounted upon a printed circuit board 5′ for incorporating with a connector 4′

The fixing member 2′ includes a pair of supporting portions 21′ at two opposite ends of the body 20′, each equipped with a solder pads 22′ for mounting to the printed circuit board 5′. The latching member 3′ includes a main body 30′, and a middle portion 31′ extending from the main body 30′, a pair of spring arms 32′ extending from two opposite sides of the middle portion 31′, each of said pair of deflection arms including a hook section 33′. The latching member 3′ further includes a pair of side portions 34′ extending from the main body 30′ by two sides of the middle portion 31′, a vertical retention section 36′ and the horizontal retention section 37′ extend from the corresponding side portion 34′ for securing the latching member 3′ to the fixing member 2′. A positioning post 35′ extends from the corresponding side portion 34′ for cooperating with the corresponding hook section 33′. A pair of stoppers 300′ are formed at two opposite ends of the main body 30′ so as to prevent over-deflection of the corresponding spring arm 32′.

The supporting portion 21′ extends in a front-to-back direction with a top face 210′, a bottom face 211′ and a side face 212′ therebewteen. A notch 213′ is formed in the supporting portion 21′ with a recess 214′ beside said notch 213′ in an undersurface of the supporting portion 21′ for receiving the horizontal retention section 37′ so as to assemble the latching member 3′ to the fixing member 2′.

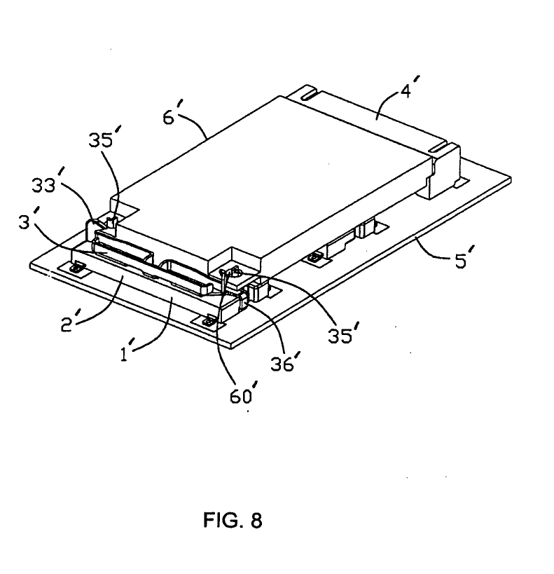

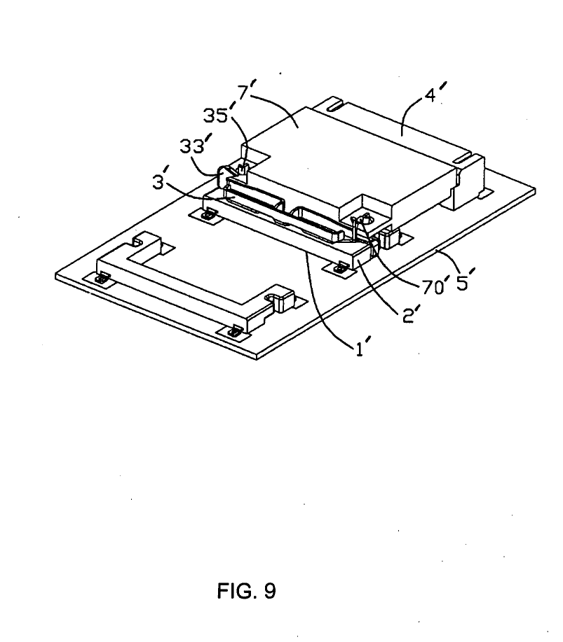

The advantage of the second embodiment includes the latching member 3′ is easily detachable from and attachable to the fixing member 2′ via said notch 213′ under an L-shaped path. Therefore, when a long card 6′ is used, the front latching member 3′ can be detached from the corresponding front fixing member 2′ of the front latching device 1′ to leave the corresponding space above the front fixing member 2′ so as to allow the long card 6′ to pass through, as shown in FIG. 8, wherein the locking hole 60′ of the long card 6′ receives the positioning post 35′ of the rear latching member 3′, and the hook section 33′ of the rear latching member 3′ latches the rear edge of the long card 6′. Understandably, the height of the fixing member 2′ should not too large so as to interfere with assembling of the long card 6′. On the other hand, when a short card 7′ is used, the rear latching member 3′ can be detached from the corresponding front fixing member 2′ of the front latching device 1′ while the front latching member 3′ is kept as shown in FIG. 9, wherein the locking hole 70′ of the short card 7′ receives the positioning post 35′ of the front latching member 3′, and the hook section 33′ of the front latching member 3′ latches the rear edge of the short card 7′.

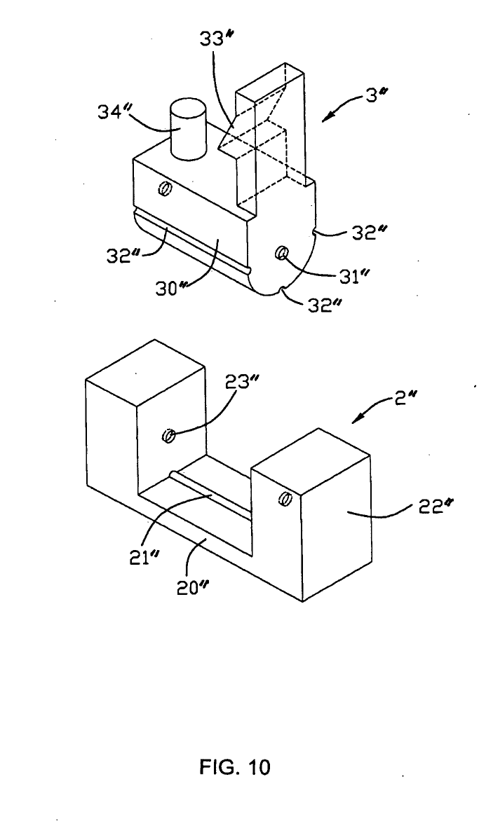

It is noted that in the second embodiment the latching member 3′ is completely removable from the corresponding fixing member 2′. Differently, FIG. 10 shows another embodiment wherein the fixing member 2″ is constantly mounted upon the corresponding printed circuit board while the latching member 3″ is rotatable relative to the fixing member 2″ without complete removal therefrom. In this embodiment, the pair of supporting portions 22″ located by two ends of the body 20″ defines a pivot hole 23″, and a round retention protrusion 21″ is formed in the body 20″. The latching member 3″ includes a main body 30″ with a pair of pivot shafts 31″ formed on two opposite ends, a positioning post 34″ and a hook section 33″ extending around said two ends wherein two round retention grooves 32″ are formed in an exterior face of the main body 30″ for selective engagement with the corresponding retention protrusion 21″. Understandably, when the long card is used, the front latching member 3″ of the front latch device 1″ should lie in a laying manner while when the short card is used, the front latching member 3″ should be in an upstanding manner.

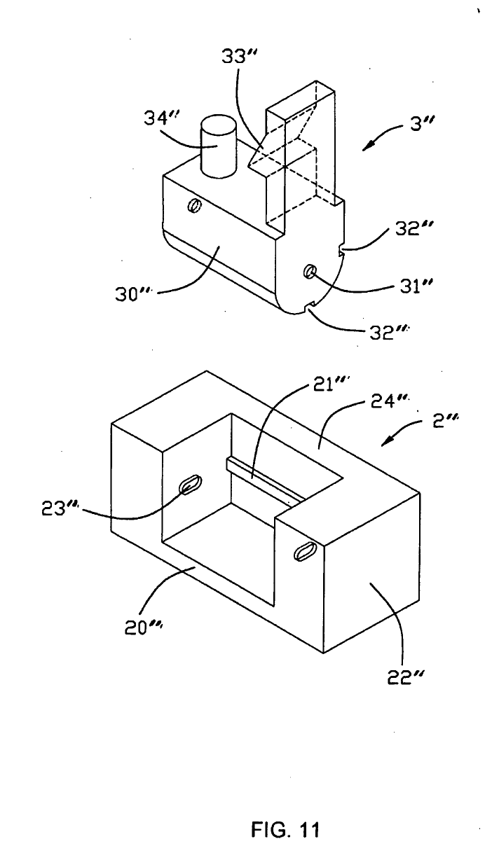

FIG. 11 shows a fourth embodiment wherein the rectangular retention protrusion 21″ is formed on the wall 24″ to be selectively received in the corresponding rectangular retention grooves 32″ and the pivotal holes 23″ is of a capsular shape rather than a circular shape.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A latching device for retaining two daughter printed circuit boards, comprising:
a fixing member of one piece comprising an elongated main body, a pair of supporting portions extending from each side of the main body to support one daughter printed circuit board; and
a pair of metallic latching members secured to the fixing member to cooperate with the supporting portions to latch and unlatch the daughter printed circuit boards.

2. The latching device as described in claim 1, wherein the fixing member is a H-like shape, and the pair of latching members are separately retained in two sides of the main body.

3. The latching device as described in claim 2, wherein the main body defines retaining slots at each side thereof, and the two latching members are retained in the corresponding retaining slots.

4. The latching device as described in claim 3, wherein the main body defines retaining portions projecting upwards at each side thereof, the retaining portions space from sidewalls of the main body and the retaining slots are defined therebetween.

5. The latching device as described in claim 4, wherein each latching member defines a retaining section and a pair of spring arms extending from the retaining section, the retaining section is retained in the retaining slots, and a hook section is located at a distal end of each spring arm to engage with the daughter printed circuit board.

6. The latching device as described in claim 5, wherein the pair of latching members are symmetrical.

7. An electrical connector assembly comprising:
a mother printed circuit board;
a pair of card edge connectors located on the mother printed circuit board oppositely and spaced from each other;
a latching device located between the two connectors, the latching device including a fixing member mounted to the printed circuit board and a pair of latching members retained to the fixing member;
the fixing member comprising supporting portions at each side thereof to support a daughter printed circuit board thereon, and each latching member including hook sections to engage with the daughter printed circuit board.

8. The electrical connector assembly as described in claim 7, wherein the fixing member defines a main body, the supporting portions extend from each side of the main body, and the latching members are separately retained in two sides of the main body.

9. The electrical connector assembly as described in claim 8, wherein the fixing member includes positioning posts extending through corresponding positioning holes of the daughter printed circuit boards.

10. The electrical connector assembly as described in claim 9, wherein said fixing member defines means for preventing over-deflection of the latching members forwards.

11. An electrical connector assembly comprising:
a printed circuit board defining a mounting surface;
an electrical connector located on a first position of the mounting surface;
a first latching device positioned on a second position of the mounting surface and spaced from the connector with a first distance in a front-to-back direction so as to cooperate with the connector to retaining a short card above the mounting surface; and
a second latching device positioned on a third position of the mounting surface and spaced from the connector with a second distance larger than the first distance so as to cooperate with the connector to retain a long card above the mounting surface; wherein
said first latching device includes a fixing member constantly mounted upon the mounting surface in stationary manner, and a latching member having the hook section thereon and moveably attached to the fixing member either in an relaxed status to allow said long card to pass when the long card is latched by said second fixing device, or in a working status to latch the short card.

12. The electrical connector assembly as claimed in claim 11, wherein said first latching member is able to be completely removed from the fixing member.

13. The electrical connector assembly as claimed in claim 11, wherein said first latching member is rotated with regard to the fixing member in a constantly associated manner between the relaxed status and the working status.

14. The electrical connector assembly as claimed in claim 13, wherein said latching member is rotated to a horizontal position during said relaxed status while to a vertical position during said working status.

15. The electrical connector assembly as claimed in claim 11, wherein said first latching member further includes a positioning post for cooperating with a locating hole in the corresponding short card.

16. The electrical connector assembly as claimed in claim 11, wherein said first latching member is rotated with regard to the fixing member about a pivotal axis extending along a direction parallel to a longitudinal direction of an insulative housing of the connector perpendicular to said front-to-back direction.

17. The electrical connector assembly as claimed in claim 16, wherein said hook section essentially latches a side edge of the short card rather than a rear edge.

18. The electrical connector assembly as claimed in claim 16, wherein said latching member is not only rotated with regard to the fixing member but also moved along a front-to-back direction with regard to the fixing member.
